(19) United States
(12) Patent Application Publication
(10) Pub. No.: US 2009/0073272 A1
(43) Pub. Date: Mar. 19, 2009

(54) DIGITAL IMAGE CAPTURING SYSTEM AND CONTROL METHOD THEREOF

(75) Inventors: WEI-JEN WANG, Tu-Cheng (TW); SHIH-PAO CHENG, Tu-Cheng (TW); SHIH-LONG KUO, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/131,045

(22) Filed: May 31, 2008

(30) Foreign Application Priority Data
Sep. 19, 2007 (CN) 200710201764.7

(51) Int. Cl. H04N 5/225

(52) U.S. Cl. 348/220.1; 348/207.99; 348/E05.024

(57) ABSTRACT

A control method of a digital still camera (DSC) is disclosed. User input is first required. The user input is then compared to user access information stored in the DSC to find a match. If the match is found, the user is allowed to operate the DSC based upon access parameters associated with the match, which is described in the user access information stored in the DSC.

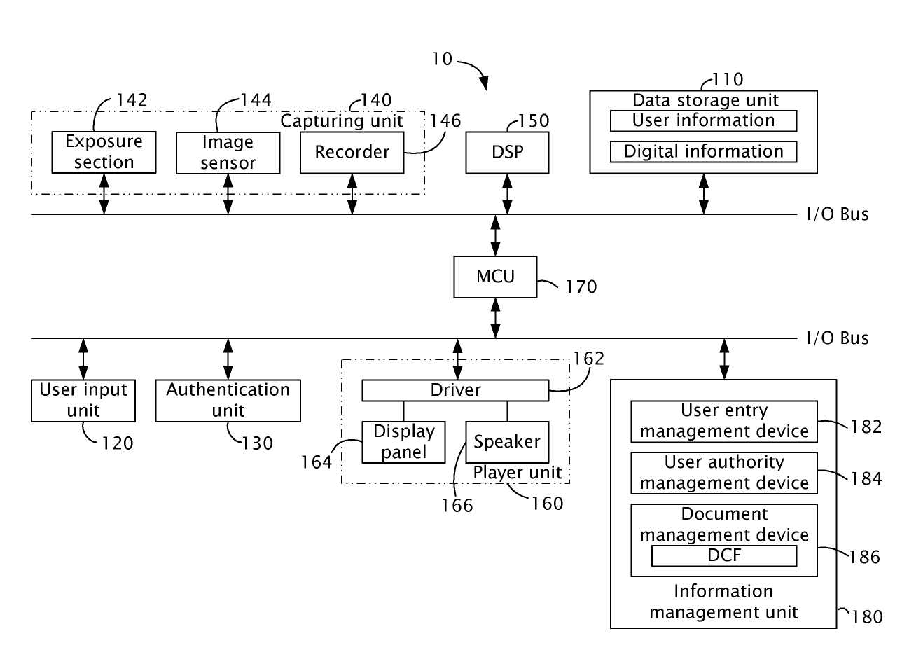

### BACKGROUND

1. Technical Field

The invention relates to image capturing devices and, particularly, to a multi-user digital image capturing system and a control method thereof.

2. Description of Related Art

Digital image capturing systems such as digital still cameras (DSCs) allow any user to view and edit (including copying, cutting, and deleting) all photos stored therein. This is convenient for the users to handle the photos. However, this may also lead to unpleasant privacy leakage and/or unauthorized editing of the photos when the systems are lent out to others.

Therefore, it is desirable to provide a digital image capturing system and a control method thereof, which can overcome the above-mentioned problem.

### SUMMARY

In an exemplary embodiment, a control method of a digital still camera (DSC) is disclosed. User input is first required. The user input is then compared to user access information stored in the DSC to find a match. If a match is found, the user is allowed to operate the DSC based upon access parameters associated with the match, which is described in the user access information stored in the DSC.

### BRIEF DESCRIPTION OF THE DRAWING

The FIGURE is a functional diagram of a digital image capturing system according to an embodiment.

### DETAILED DESCRIPTION OF THE EMBODIMENTS

Embodiments of the present digital image capturing system and control method will now be described in detail with reference to the drawing. The digital image capturing system can be, but is not limited to, a digital still camera (DSC) or a digital video camera. In the following embodiments, the digital image capturing system is a DSC.

Referring to the FIGURE, a DSC 10, according to an exemplary embodiment, includes a data storage unit 110, a user input unit 120, and an authentication unit 130. The data storage unit 110 is configured for storing user information and digital information, e.g., a photo file(s), an audio file(s), and a video file(s). The user information includes user access information and user access parameters. In particular, the user access information contains, for example, the following user entries: an owner, a named guest/guests, and an anonymous guest. The user access parameters define specific operations of the DSC 10 that the user is authorized to access. For example, the operations authorized for access by the owner of the DSC 10 may be unlimited and include: taking and saving a photo/video, viewing, copying, cutting, and deleting all photos/videos, building a user entry, deleting all user entries, and changing access parameters of all user entries. On the other hand, a family member may only have taking, saving, and viewing privileges. The user access information and the user access parameters are associated and indexed as a database. The user input unit 120 is configured for receiving input of a user. The authentication unit 130 is configured for comparing the input of the user and the user access information, and thereby determining what operations if any are authorized of the DSC 10 for the user.

The user input unit 120 can include a fingerprint sensor, a touch screen, a keypad, an audio input device (e.g. a recorder), and/or a face capturing device (e.g. a camera module) configured for receiving a fingerprint of the user, a unique password input by the user, a voice of the user, and a face of the user, respectively. Accordingly, the authentication unit 130 can include a fingerprint identification device, a password identification device, an audio identification device, and/or a face recognition device. In this embodiment, the user input unit 120 is a keypad, and the authentication unit 130 is a password identification device.

Specifically, in addition to the data storage unit 110, the user input unit 120, and the authentication unit 130, the DSC 10 typically further includes a capturing unit 140, a digital signal processor (DSP) 150, a player unit 160, a micro control unit (MCU) 170, and an information management unit 180. The data storage unit 110, the user input unit 120, the authentication unit 130, the capturing unit 140, the DSP 150, the player unit 160, and the management unit 180 can communicate with the MCU 170 via an I/O bus.

The capturing unit 140 is configured for capturing an image/images and a video/videos, and typically includes an exposure section 142 (an arrangement of a pickup lens and a mechanical shutter), an image sensor 144, and a recorder 146. The exposure section 142 is configured for exposing the image sensor to light emitted from a subject and directed therethrough. The image sensor 144, such as a charge coupled device image sensor, is configured for converting the light into an image signal. The recorder 146 is configured for recording audio on demand or when video is being captured.

The DSP 150 is configured for processing the image signal to extract control data such as auto focus data, auto exposure data, or auto white balance data, and encoding/decoding the image signal, which can be utilized for setting the exposure section 142 and the image sensor 144 to obtain a high quality image. The DSP 150 is also configured for encoding and decoding the image signal into a specific format for storage and display. After being encoded, the image signal and/or audio signal are stored in the data storage unit 110 as a portion of the digital information.

The player unit 160 typically includes a driver 162, a display panel 164, and a speaker 166. The driver 162 is configured for receiving the image signal or the audio signal via the DSP 150 (for decoding), and driving the display panel 164 to show the image, and the speaker 166 to play the recorded audio.

The MCU 170 is configured for receiving the control data from the DSP 150, and user input/inputs from the user input unit 120, and accordingly controlling the DSC 10 to perform various corresponding functions, such as zooming in/out, user authentication, and information management.

The information management unit 180 is configured for managing the user information and the digital information. In particular, the information management unit 180 includes a user access management unit 182, a user access parameter management unit 184, and a document management unit 186. The user access management unit 182 is configured for managing the user input, for example, building or deleting a user entry, according to input of a master user (owner) who has unlimited access. The user access parameter management unit 184 is configured for managing access to functions and files according to the access parameters of a user, as input by the master user. The document management unit 186 is configured for managing the digital information.

In particular, the document management unit 186 can be a design rule for camera file system (DCF). This DCF defines file format and a file system for the digital information, including the directory structure, file naming method, character set, file set, and metadata format. Typically, the root directory of the DCF contains a digital camera image (DCIM) directory, which may contain multiple subdirectories. Each subdirectory is only accessible to a user whose user access parameters are associated with that subdirectory.

Understandably, various components of the DSC 10, such as the authentication unit 130, the information management unit 180, and the driver 162 can be integrated into a single control unit. Alternatively, such components can instead be software instructions written via a variety of software languages, including C, C++, Java, Visual Basic, and many others, and can be executed by hardware such as an FPGA or an ASIC to provide the above-mentioned functionality of the components.

When using the DSC 10, an authentication step is first required. In detail, an input is first required from a user. This input is compared to the user access information to find a match. If a match is found, the user is allowed to operate the DSC 10 based upon the access parameters associated with the match, which are described in the user access information. If no match is found, a message will be displayed to remind the user to reenter their input (e.g. up to 3 times) or locking the DSC 10 (e.g. after 3 wrong inputs).

Clearly, the DSC 10 can reduce the risk of unauthorized access to, and use of, digital information.

It will be understood that the above particular embodiments and methods are shown and described by way of illustration only. The principles and the features of the present invention may be employed in various and numerous embodiment thereof without departing from the scope of the invention as claimed. The above-described embodiments illustrate the scope of the invention but do not restrict the scope of the invention.

What is claimed is:

1. A digital image capturing system comprising:
a data storage unit for storing user information and digital information, the user information including user access information and user access parameters;
a user input unit for receiving input of a user; and
an authentication unit for comparing the input of the user with the user access information, and thereby determining what operation authority of the digital image capturing system the user has based upon the user access parameters.

2. The digital image capturing system as claimed in claim 1, wherein the digital information includes a file selected from a group of: an image file, an audio file, and a video file.

3. The digital image capturing system as claimed in claim 1, wherein the user input unit includes an element selected from a group of: a fingerprint sensor, a touch screen, a keypad, an audio input device, and a face capturing device.

4. The digital image capturing system as claimed in claim 1, wherein the authentication unit includes an element selected from a group of: a fingerprint identification device, a password identification device, an audio identification device, and a face recognition device.

5. The digital image capturing system as claimed in claim 1, wherein the operation authority of the digital image capturing system includes an operation selected from a group of: taking an image, taking a video, viewing an image, viewing a video, saving an image, saving a video, copying an image, copying a video, cutting an image, cutting a video, deleting an image, deleting a video, building a user entry, deleting a user entry, and changing the authority of a user entry.

6. The digital image capturing system as claimed in claim 1, further comprising a capturing unit, the capturing unit being configured for capturing an image.

7. The digital image capturing system as claimed in claim 1, further comprising a player unit, the player unit being configured for playing the digital information.

8. The digital image capturing system as claimed in claim 1, further comprising an information management unit, the information management unit being configured for managing the user information and the digital information.

9. The digital image capturing system as claimed in claim 8, wherein the information management unit includes a user entry management unit, a user authority management unit, and a document management unit, the user entry management unit being configured for managing the user access information, the user authority management unit being configured for managing the user access parameters, and the document management unit being configured for managing the digital information.

10. The digital image capturing system as claimed in claim 9, wherein the document management unit includes a design rule for a camera file system.

11. The digital image capturing system as claimed in claim 1, being selected from a group of a digital still camera, and a digital video camera.

12. A control method of a digital image capturing system, the digital image capturing system comprising a data storage unit, the data storage unit being configured for storing user information and digital information, the user information comprising user access information and user access parameters, the control method comprising:
receiving input of a user;
comparing the input of the user with the user access information to determine what operation authority of the digital image capturing system the user has based upon the user access parameters; and
allowing the user to operate the digital image capturing system within the determined operation authority.

13. The control method as claimed in claim 1, wherein the operation authority includes zero authority.
